(19) United States
(12) Patent Application Publication
(10) Pub. No.: US 2016/0165081 A1
(43) Pub. Date: Jun. 9, 2016

(54) IMAGE PROCESSING APPARATUS AND SCREEN DISPLAY METHOD

(71) Applicant: KYOCERA Document Solutions Inc., Osaka (JP)

(72) Inventor: Ryo Shiomi, Osaka (JP)

(21) Appl. No.: 14/957,439

(22) Filed: Dec. 2, 2015

(30) Foreign Application Priority Data
Dec. 4, 2014 (JP) 2014-245820

(51) Int. Cl. H04N 1/00; H04N 1/21

(52) U.S. Cl. CPC H04N 1/00469; H04N 1/0057; H04N 1/2104; H04N 1/00204; H04N 2201/0094

(57) ABSTRACT

An image processing apparatus includes a job execution portion, a screen data processing portion, and a display processing portion. The job execution portion is configured to access a memory connected via a bus and execute a job associated with image processing. The screen data processing portion is configured to store predetermined first screen data in the memory when the job is not being executed by the job execution portion, and store, in the memory, predetermined second screen data having a data amount less than the first screen data when the job is being executed by the job execution portion. The display processing portion is configured to display a screen based on the first screen data or the second screen data which is stored in the memory connected via the bus.

### INCORPORATION BY REFERENCE

This application is based upon and claims the benefit of priority from the corresponding Japanese Patent Application No. 2014-245820 filed on Dec. 4, 2014, the entire contents of which are incorporated herein by reference.

### BACKGROUND

The present disclosure relates to image processing apparatuses and a screen display method for image processing apparatuses.

In general, image processing apparatuses such as copying machines are provided with operation display portions such as touch panels for allowing users to make operation input to the image processing apparatuses. A user who uses this type of image processing apparatus, makes operation input according to a screen displayed on the operation display portion, thereby causing the image processing apparatus to execute a job such as a copy job associated with image processing.

### SUMMARY

An image processing apparatus according to one aspect of the present disclosure includes a job execution portion, a screen data processing portion, and a display processing portion. The job execution portion is configured to access a memory connected via a bus and execute a job associated with image processing. The screen data processing portion is configured to store predetermined first screen data in the memory when the job is not being executed by the job execution portion, and store, in the memory, predetermined second screen data having a data amount less than the first screen data when the job is being executed by the job execution portion. The display processing portion is configured to display a screen based on the first screen data or the second screen data which is stored in the memory connected via the bus.

A screen display method according to another aspect of the present disclosure includes a first step, a second step, and a third step described below. In the first step, a memory connected via a bus is accessed and a job associated with image processing is executed. In the second step, predetermined first screen data is stored in the memory when the job is not being executed in the first step, and predetermined second screen data having a data amount less than the first screen data is stored in the memory when the job is being executed in the first step. In the third step, a screen is displayed based on the first screen data or the second screen data which is stored in the memory connected via the bus.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 illustrates a configuration of an image processing apparatus according to an embodiment of the present disclosure.

FIG. 2 is a block diagram illustrating a system configuration of the image processing apparatus according to the embodiment of the present disclosure.

FIG. 3 is a block diagram illustrating a configuration of a second control portion of the image processing apparatus according to the embodiment of the present disclosure.

FIG. 4 is a flow chart showing an example of a display screen control process executed by the image processing apparatus according to the embodiment of the present disclosure.

### DETAILED DESCRIPTION

An embodiment of the present disclosure will be described below with reference to the accompanying drawings, to allow understanding of the present disclosure. The embodiment described below represents an exemplary implementation of the present disclosure, and the technical scope of the present disclosure is not limited to the embodiment described below.

[Schematic Configuration of Image Processing Apparatus 10]

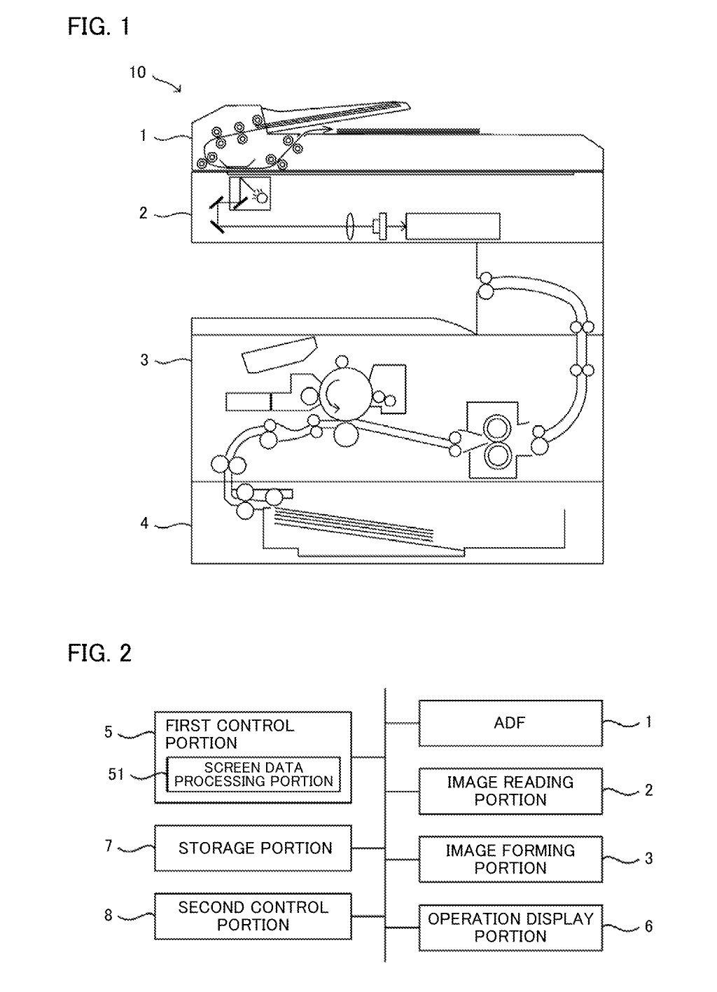

Firstly, a schematic configuration of an image processing apparatus 10 according to an embodiment of the present disclosure will be described with reference to FIG. 1 and FIG. 2. FIG. 1 is a schematic cross-sectional view of the image processing apparatus 10.

As shown in FIG. 1 and FIG. 2, the image processing apparatus 10 includes an ADF 1, an image reading portion 2, an image forming portion 3, a sheet feed portion 4, a first control portion 5, an operation display portion 6, a storage portion 7, and a second control portion 8. The image processing apparatus 10 is a multifunction peripheral that has a plurality of functions including not only a printing function of forming an image based on image data, but also a scanning function, a facsimile function, or a copying function. Further, the technique of the present disclosure can be applied to image processing apparatuses such as scanning apparatuses, printing apparatuses, facsimile apparatuses, and copying machines.

The ADF 1 is an automatic document feeder that includes a document set portion, a plurality of feed rollers, a document holder, and a document sheet discharge portion, and that feeds a document to be read by the image reading portion 2. The image reading portion 2 includes a document table, a light source, a plurality of mirrors, an optical lens, and a CCD (Charge Coupled Device), and can execute an image reading process of reading image data from a document.

The image forming portion 3 can execute an image forming process (printing process) of forming an image by electrophotography based on image data read by the image reading portion 2 or image data having been inputted from an external information processing apparatus such as a personal computer. Specifically, the image forming portion 3 includes a photosensitive drum, a charging device, a laser scanning unit (LSU), a developing device, a transfer roller, a cleaning device, a fixing roller, a pressure roller, and a sheet discharge tray. In the image forming portion 3, an image is formed on a sheet fed by the sheet feed portion 4, and the sheet having the image formed thereon is discharged onto the sheet discharge tray. The sheet is a sheet material such as paper, coated paper, a postcard, an envelope, and an OHP sheet.

The first control portion 5 includes control devices such as a CPU, a ROM, a RAM, and an EEPROM (registered trademark) which are not shown. The CPU is a processor that executes various arithmetic processes. The ROM is a non-volatile storage portion in which information such as a control program for causing the CPU to execute various processes is previously stored. The RAM is a volatile storage portion, and the EEPROM is a non-volatile storage portion. The RAM and the EEPROM are used as temporary storage memories (work areas) for various processes to be executed by the CPU. The first control portion 5 comprehensively controls the image processing apparatus 10 by causing the CPU to execute the various control programs that are previously stored in the ROM.

The operation display portion 6 has: a display portion such as a liquid crystal display for displaying various information according to control instructions from the first control portion 5; and an operation portion such as an operation key or a touch panel for allowing input of various information to the first control portion 5 according to an operation performed by a user.

The storage portion 7 is a storage device such as an SSD (solid-state drive) or an HDD (hard disk drive). In the storage portion 7, for example, image data read by the image reading portion 2 is stored.

In the image processing apparatus 10, a job associated with image processing is executed by the first control portion 5 executing the control program. Specifically, the job executed by the image processing apparatus 10 includes a scan job, a print job, a fax job, and a copy job.

The scan job is a job for transmitting, to an external information processing apparatus, image data of a document read by the image reading portion 2. The print job is a job for causing the image forming portion 3 to print image data transmitted from an external information processing apparatus. The fax job is a job for executing facsimile communication with an external facsimile communication apparatus. Specifically, the fax job includes a facsimile transmission job for transmitting, to an external facsimile communication apparatus, image data of a document read by the image reading portion 2, and a facsimile reception job for causing the image forming portion 3 to print image data transmitted from an external facsimile communication apparatus. The copy job is a job for causing the image forming portion 3 to print image data of a document read by the image reading portion 2.

The scan job may be a job for storing, in the storage portion 7, image data of a document read by the image reading portion 2. Further, the print job may be a job for causing the image forming portion 3 to print image data stored in the storage portion 7.

In conventional image processing apparatuses having the above-mentioned configuration, in a case where screen display is performed on the operation display portion 6 while the job is being executed, conflict in access to a memory between a module for executing the job, and a module for causing the operation display portion 6 to display a screen may occur and lead to reduction in a speed at which the job is executed. In view thereof, performance of a bus that connects between each module and the memory may be enhanced. However, cost or power consumption may be increased accordingly. Alternatively, an internal memory in which screen data is stored may be provided in the module for causing the operation display portion 6 to display a screen. However, cost is increased accordingly. Meanwhile, in the image processing apparatus 10, with a simple configuration, reduction of a job executing speed due to screen display being performed while the job is being executed can be less likely to occur, as described below.

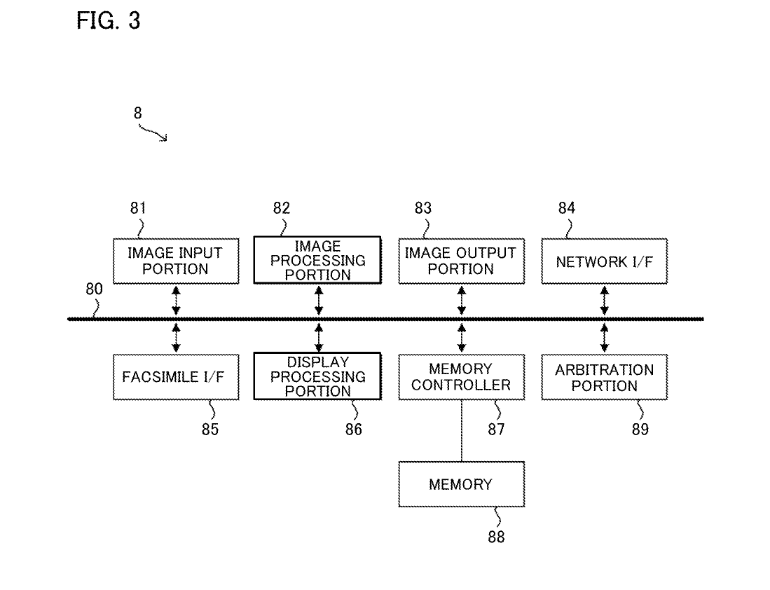

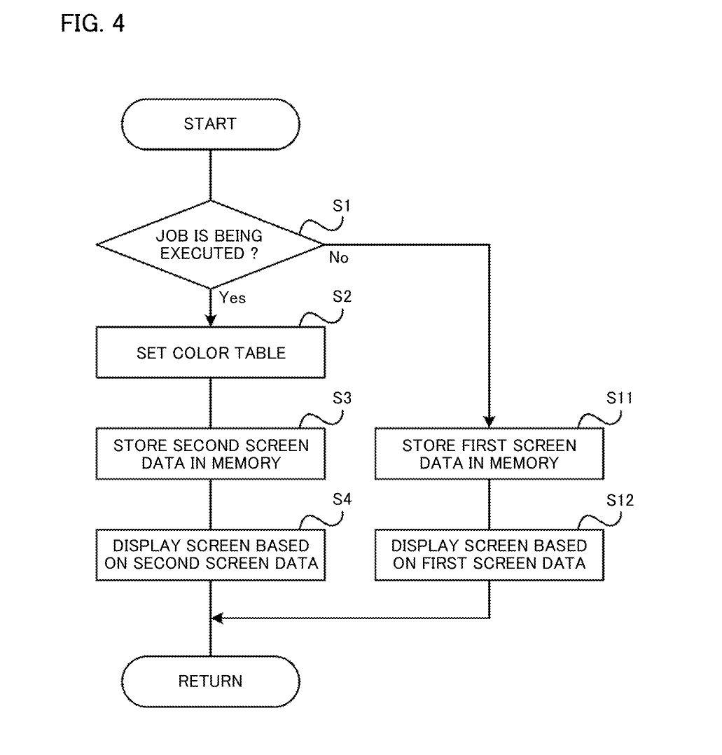

The second control portion 8 will be described below with reference to FIG. 3 and FIG. 4.

The second control portion 8 is an integrated circuit that is provided separately from the first control portion 5 that comprehensively controls the image processing apparatus 10, and includes a plurality of modules for the functions of the image processing apparatus 10. For example, the second control portion 8 is implemented as an ASIC.

Specifically, as shown in FIG. 3, the second control portion 8 includes an image input portion 81, an image processing portion 82, an image output portion 83, a network I/F 84, a facsimile I/F 85, a display processing portion 86, a memory controller 87, a memory 88, and an arbitration portion 89. Further, in the second control portion 8, the image input portion 81, the image processing portion 82, the image output portion 83, the network I/F 84, the facsimile I/F 85, the display processing portion 86, the memory controller 87, and the arbitration portion 89 are connected via a bus 80 so as to communicate with each other.

The image input portion 81 executes image processing such as a shading correction process, a gamma correction process, or the like for image data inputted from the CCD of the image reading portion 2, and stores, in the memory 88 or the storage portion 7, image data having been subjected to the image processing.

The image processing portion 82 executes image processing for image data read from the memory 88, and stores, in the memory 88, image data having been subjected to the image processing. For example, the image processing portion 82 executes image processing such as a compression/decompression process, a rotation process, and a scaling process for the image data.

The image output portion 83 reads the image data from the memory 88, executes image processing such as screen processing, and outputs image data having been subjected to the image processing, to the laser scanning unit of the image forming portion 3.

The network I/F 84 is an interface that allows communication with an external information processing apparatus connected via a communication network. For example, the network I/F 84 receives, via the communication network, image data transmitted from the external information processing apparatus, and stores the image data in the memory 88.

The facsimile I/F 85 is an interface that allows facsimile communication with an external facsimile communication apparatus connected via a telephone network. For example, the facsimile I/F 85 has a modem that enables conversion between a digital signal transmitted via the bus 80 and an analog signal transmitted via the telephone network.

The image input portion 81, the image processing portion 82, the image output portion 83, the network I/F 84, and the facsimile I/F 85 access the memory 88 connected via the bus 80 to execute the job according to a control signal transmitted from the first control portion 5. The image input portion 81, the image processing portion 82, the image output portion 83, the network I/F 84, and the facsimile I/F 85 are examples of a job execution portion of the present disclosure. Hereinafter, when these portions need not be distinguished from each other, these portions are referred to as a job execution portion 8X.

For example, when an operation for executing the scan job is performed on the operation display portion 6, the first control portion 5 causes the image input portion 81, the image processing portion 82, and the network I/F 84 to execute the scan job. When image data transmitted from an external information processing apparatus is received, the first control portion 5 causes the image processing portion 82, the image output portion 83, and the network I/F 84 to execute the print job.

Further, when an operation for executing the facsimile transmission job is performed on the operation display portion 6, the first control portion 5 causes the image input portion 81, the image processing portion 82, and the facsimile I/F 85 to execute the facsimile transmission job. Moreover, when image data transmitted from an external facsimile communication apparatus is received, the first control portion 5 causes the image processing portion 82, the image output portion 83, and the facsimile I/F 85 to execute the facsimile reception job. When an operation for executing the copy job is performed on the operation display portion 6, the first control portion 5 causes the image input portion 81, the image processing portion 82, and the image output portion 83 to execute the copy job.

The display processing portion 86 is caused to display a screen based on screen data stored in the memory 88, by the first control portion 5. Specifically, the display processing portion 86 obtains the screen data from the memory 88 according to a control signal transmitted from the first control portion 5. The display processing portion 86 causes the operation display portion 6 to display a screen based on the screen data having been obtained. The display processing portion 6 periodically accesses the memory 88 and thus maintains or changes contents of the screen displayed by the operation display portion 6.

The memory controller 87 executes a process of writing image data into the memory 88 and a process of reading image data from the memory 88 according to a request, for accessing the memory 88, from the job execution portion 8X and the display processing portion 86.

The memory 88 is a storage device used as a work area for image processing performed by the job execution portion 8X and the display processing portion 86. For example, a DDR-SDRAM is used for the memory 88.

In a case where conflict in access to the memory 88 occurs between the job execution portions 8X or between the job execution portion 8X and the display processing portion 86, the arbitration portion 89 arbitrates the conflict in access to the memory 88, based on priorities that are preset for the job execution portions 8X and the display processing portion 86. The arbitration by the arbitration portion 89 may be performed in a well-known conventional method.

Meanwhile, the first control portion 5 includes a screen data processing portion 51, as shown in FIG. 2. Specifically, in the ROM of the first control portion 5, a display screen control program for causing the CPU to execute a display screen control process described below (see FIG. 4) is previously stored. The display screen control program may be stored in a non-transitory computer-readable storage medium such as a CD, a DVD, or a flash memory, read from the storage medium, and installed into a storage portion such as the EEPROM of the first control portion 5. The first control portion 5 causes the CPU to execute the display screen control program stored in the ROM, thereby functioning as the screen data processing portion 51.

When the job is not being executed by the job execution portion 8X, the screen data processing portion 51 stores predetermined first screen data in the memory 88. When the job is being executed by the job execution portion 8X, the screen data processing portion 51 stores, in the memory 88, predetermined second screen data having a data amount that is less than the first screen data. For example, the screen data processing portion 51 stores, in the memory 88, one of the first screen data and the second screen data that are previously stored in the ROM, according to whether or not the job is being executed by the job execution portion 8X.

Specifically, in the image processing apparatus 10, the number of display colors of a screen displayed based on the second screen data is less than the number of display colors of a screen displayed based on the first screen data. For example, in the image processing apparatus 10, a data amount, per one pixel, of the first screen data is 24 bits, and the number of display colors of a screen displayed based on the first screen data is 16,777,216, while a data amount, per one pixel, of the second screen data is 8 bits, and the number of display colors of a screen displayed based on the second screen data is 256.

The screen data processing portion 51 transmits a control signal to the display processing portion 86, and causes the display processing portion 86 to obtain the first screen data or the second screen data which is stored in the memory 88. The display processing portion 86 obtains the first screen data or the second screen data from the memory 88 according to the control signal transmitted from the screen data processing portion 51, and causes the operation display portion 6 to display a screen based on the first screen data or the second screen data.

The display processing portion 86 uses colors that are designated according to a predetermined color table to perform screen display based on the second screen data. For example, in the image processing apparatus 10, a plurality of color tables each having 256 colors selected from among display colors of a screen displayed based on the first screen data are previously stored in the ROM. The screen data processing portion 51 stores, in the memory 88, one of the plurality of color tables stored in the ROM. The screen data processing portion 51 transmits a control signal to the display processing portion 86, and causes the display processing portion 86 to obtain the color table stored in the memory 88, thereby setting the color table in the display processing portion 86.

Meanwhile, in the image processing apparatus 10, 8 bits of pixel data of the second screen data are each associated with a table number of the color table. The display processing portion 86 converts the 8 bits of pixel data of the second screen data to 256 bits of pixel data having the colors designated by the color table, based on the color table having been set by the screen data processing portion 51. The display processing portion 86 causes the operation display portion 6 to display a screen based on the second screen data obtained by the conversion.

[Display Screen Control Process]

An example of a procedure of the display screen control process executed by the first control portion 5 in the image processing apparatus 10 according to the display screen control program will be described below with reference to FIG. 4. Step S1, S2 . . . represent the numbers of the process procedure (steps) executed by the first control portion 5. When a predetermined lighting condition of the operation display portion 6 is satisfied, the first control portion 5 executes the display screen control process. For example, the lighting condition represents, for example, a condition that an operation has been performed on the operation display portion 6 by a user. When a predetermined extinguishing condition of the operation display portion 6 is satisfied, the first control portion 5 ends the display screen control process. For example, the extinguishing condition represents, for example, a condition that a state where no operation is performed on the operation display portion 6, has continued for a predetermined time period.

<Step S1>

Firstly, in step S1, the first control portion 5 determines whether or not the job is being executed.

When the first control portion 5 determines that the job is being executed, (Yes in S1), the process is shifted to step S2. A process executed by the job execution portion 8X according to an instruction, for executing the job, from the first control portion 5, represents an example of a first step of the present disclosure. Further, when the job is not being executed (No in S1), the first control portion 5 shifts the process to step S11.

<Step S11>

In step S11, the first control portion 5 operates so as to store, in the memory 88, the first screen data stored in the ROM.

<Step S12>

In step S12, the first control portion 5 transmits, to the display processing portion 86, an instruction for obtaining the first screen data stored in the memory 88. Thus, the display processing portion 86 obtains the first screen data from the memory 88, and causes the operation display portion 6 to display a screen based on the first screen data.

<Step S2>

Meanwhile, in step S2, the first control portion 5 operates so as to store, in the memory 88, one of a plurality of the color tables stored in the ROM. The first control portion 5 transmits, to the display processing portion 86, an instruction for setting the color table stored in the memory 88. Thus, the color table stored in the memory 88 is set in the display processing portion 86.

<Step S3>

In step S3, the first control portion 5 operates so as to store, in the memory 88, the second screen data stored in the ROM. The process step of step S1, step S11, and step S3 represents an example of a second step of the present disclosure, and is executed by the screen data processing portion 51 of the first control portion 5.

<Step S4>

In step S4, the first control portion 5 transmits, to the display processing portion 86, an instruction for obtaining the second screen data stored in the memory 88. Thus, the display processing portion 86 obtains the second screen data from the memory 88, and causes the operation display portion 6 to display a screen based on the second screen data. The process executed by the display processing portion 86 in the process step of step S12 or step S4, represents an example of a third step of the present disclosure.

The display processing portion 86 uses colors designated by the color table having been set in step S2 to perform screen display based on the second screen data. Thus, display of the screen based on the second screen data can vary by the color table to be set in the display processing portion 86 being changed.

Thus, in the display screen control process, when the job is not being executed, the first screen data is stored in the memory 88, and when the job is being executed, the second screen data having a data amount less than the first screen data is stored in the memory 88. Thus, with a simple configuration, reduction, of a speed at which the job is executed, due to screen display being performed while the job is being executed, can be less likely to occur.

In another embodiment of the image processing apparatus 10, a configuration in which a size of a screen displayed based on the second screen data is less than a size of a screen displayed based on the first screen data, may be provided. For example, a configuration in which, while the first screen data and the second screen data have the same data amount per one pixel, the number of pixels of the second screen data is less than the number of pixels of the first screen data, may be provided.

In this case, the display processing portion 86 may allow the display screen based on the second screen data to be enlarged. Thus, a user may be less likely to feel uncomfortable when the screen size is different between the display screen based on the first screen data and the display screen based on the second screen data. Specifically, the display processing portion 86 may enlarge the display screen based on the second screen data by a magnification that is predetermined such that the display screen based on the second screen data and the display screen based on the first screen data have the same display size.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising:
a job execution portion configured to access a memory connected via a bus and execute a job associated with image processing;
a screen data processing portion configured to store predetermined first screen data in the memory when the job is not being executed by the job execution portion, and store, in the memory, predetermined second screen data having a data amount less than the first screen data when the job is being executed by the job execution portion; and
a display processing portion configured to display a screen based on the first screen data or the second screen data which is stored in the memory connected via the bus.

2. The image processing apparatus according to claim 1, wherein a number of display colors of the screen displayed based on the second screen data is less than a number of display colors of the screen displayed based on the first screen data.

3. The image processing apparatus according to claim 2, wherein the display processing portion uses colors designated by a predetermined color table to display the screen based on the second screen data.

4. The image processing apparatus according to claim 1, wherein a size of the screen displayed based on the second screen data is less than a size of the screen displayed based on the first screen data.

5. The image processing apparatus according to claim 4, wherein the display processing portion enlarges a display screen based on the second screen data.

6. The image processing apparatus according to claim 1, wherein the job includes one or more of a scan job, a print job, a fax job, and a copy job.

7. A screen display method comprising:
a first step of accessing a memory connected via a bus and executing a job associated with image processing;
a second step of storing predetermined first screen data in the memory when the job is not being executed in the first step, and storing, in the memory, predetermined second screen data having a data amount less than the first screen data when the job is being executed in the first step; and
a third step of displaying a screen based on the first screen data or the second screen data which is stored in the memory connected via the bus.
